(19) United States
(12) Patent Application Publication
(10) Pub. No.: US 2007/0268697 A1
(43) Pub. Date: Nov. 22, 2007

(54) Ground supported lighting device for displaying information

(76) Inventor: Hon Kwok Cheng, Hong Kong (HK)

Correspondence Address: RABIN & Berdo, PC, 1101 14TH STREET, NW, SUITE 500, WASHINGTON, DC, 20005, US

(21) Appl. No.: 11/593,506

(22) Filed: Nov. 7, 2006

(30) Foreign Application Priority Data
May 22, 2006 (CN) 200620115555.1

(51) Int. Cl. F21V 21/00

(52) U.S. Cl. 362/249; 362/431; 362/812; 362/806

(57) ABSTRACT

The present invention provides a ground lighting device for displaying information, comprising a lamp housing constructed by a frame and at least one PVC-based panel secured to the frame; at least one hollowed-out character sign attached to the PVC-based panel; a hollow ground stake connected with the frame; and a string of lamps which runs through the hollow ground stake to be arranged inside the lamp housing. The invention allows formation of a meaningful luminous character sign which may be employed for decorative and informative effects during Christmas seasons or at other situations. The hollowed-out character sign may be formed with desirable characters or words so that the ground supported lighting device of the invention finds a wide variety of applications.

### FIELD OF THE INVENTION

The present invention relates to a ground supported lighting device, and particularly to a novel ground supported lighting device for displaying information.

### BACKGROUND OF THE INVENTION

Change of decorative effects for currently available ground-supported lamp fixtures is achieved by modifying mark displays provided in the lamp fixtures in terms of function or construction. Rope lights and light strings account for most of currently available ground-supported lamp fixtures, some of which may form a chasing of light and generate sound greetings, thus giving out a relatively remarkable motion feeling. Usually, designers put their efforts into artificial modelings, colors and functions of the lamp fixtures in order to display various and wonderful styles. While attempts have been made to form character decoration, such attempts have enjoyed limited success and applications.

The present invention is to provide a novel ground lighting device for displaying information that has a totally new concept and design and is easy to manufacture, essentially characterized in that it incorporate a character sign and a ground supported lighting device as a single piece, making the ground supported lighting device to generate a specific, explicit and festive decoration.

### SUMMARY OF THE INVENTION

An object of the present invention is to provide a ground supported lighting device for displaying information that is easy to make and serves for eye-catching and informative purposes, thus heightening the joyous and festive atmosphere.

To attain this, the ground supported lighting device for displaying information according to the invention comprises:

a lamp housing constructed by a frame and at least one PVC-based panel secured to the frame;
at least one hollowed-out character sign attached to the PVC-based panel;
a hollow ground stake connected with the frame; and
a string of lamps which runs through the hollow ground stake to be arranged inside the lamp housing.

The ground supported lighting device for displaying information further comprises a hook member on top of the device so as to allow the device to be suspended.

Preferably, the hollow ground stake is configured as a transparent one. More preferably, the hollow ground stake is formed with decorative patterns.

In one preferred embodiment of the invention, the hollowed-out character sign is made of wood materials.

In the ground supported lighting device for displaying information, the hollowed-out character sign may be made in the shape of an arrow, a polygon, or a rectangular configuration incorporating Santa Clause patterns.

According to the invention, a string of lamps is used as a light source in the ground supported lighting device for displaying information and a light-transmitting PVC-based panel is arranged at the backside of the hollowed-out character sign, thereby allowing formation of a meaningful luminous character sign which may be employed for decorative and informative effects during Christmas seasons or at other situations. The hollowed-out character sign may be formed with desirable characters or words so that the ground supported lighting device of the invention finds a wide variety of applications.

The invention will now be described in more detail with reference to the accompanying figure drawings.

### BRIEF DESCRIPTION OF THE DRAWINGS

FIG. 1 is a pictorial view of the construction of the ground supported lighting device for displaying information according to a first embodiment of the invention.

FIG. 2 is a pictorial view of the construction of the ground supported lighting device for displaying information according to a second embodiment of the invention.

FIG. 3 is an exploded view of the ground supported lighting device for displaying information of FIG. 2.

FIG. 4 is a schematic diagram of an example circuit used in the ground supported lighting device for displaying information of the invention.

### DETAILED DESCRIPTION OF THE INVENTION

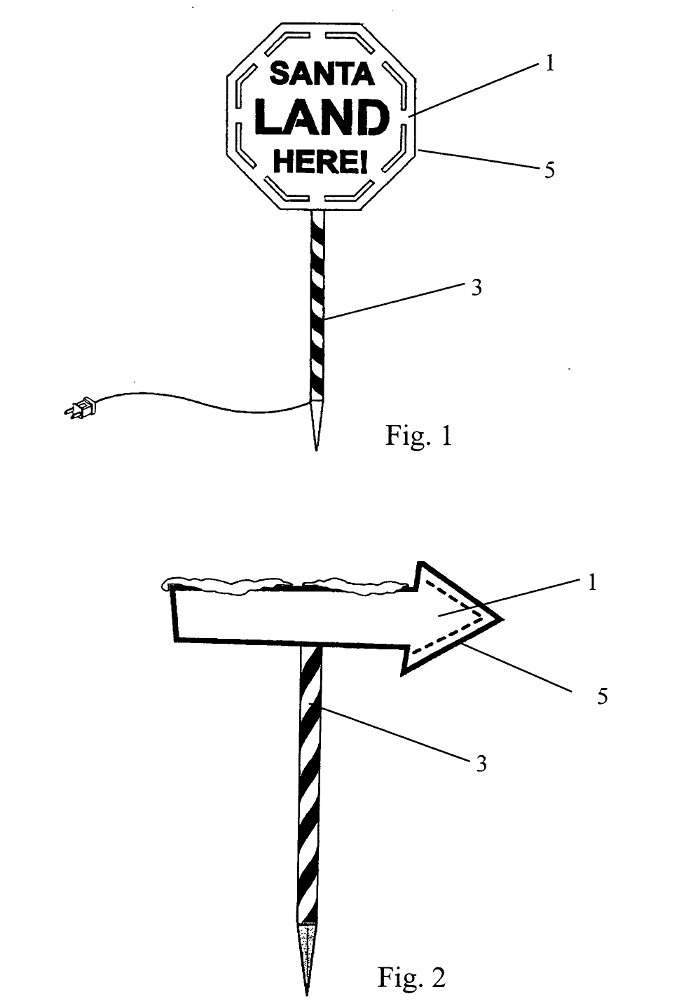

Referring to FIGS. 1 to 3, there are respectively illustrated ground supported lighting devices for displaying information according to first and second embodiments of the invention. The ground supported lighting device for displaying information generally comprises a lamp housing 5 constructed by a frame 2 and front and rear PVC panels secured to the frame, two identical hollowed-out character signs 1 attached to the PVC panels; a hollow ground stake 3 connected with the frame 2; and a string of lamps 4 which runs through the hollow ground stake 3 to be arranged inside the lamp housing 5. The hollowed-out character sign 1 is made of wood material. The hollow ground stake 3 is transparent and provided with certain patterns so as to allow it to become luminous by means of the string of lamps running therethrough. The ground supported lighting device is supported by the ground stake 3 for outdoor use.

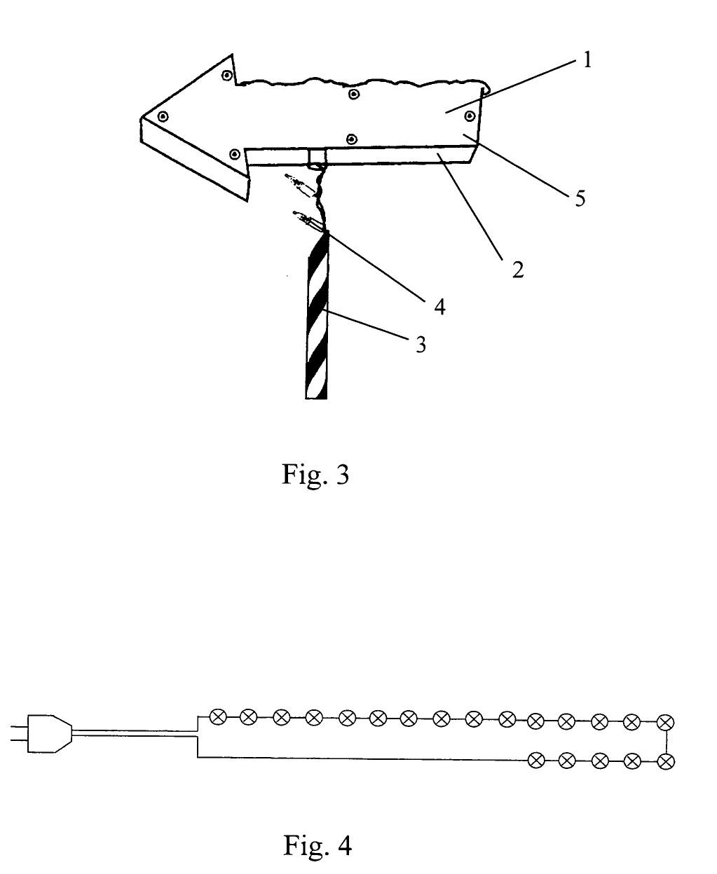

FIG. 1 shows the hollowed-out character sign formed as an octagonal configuration. FIGS. 2 and 3 show the hollowed-out character sign formed as an arrow configuration.

It is understood that the hollowed-out character sign 1 may be formed as a rectangular configuration incorporating Santa Clause patterns or the like. Suitable materials such as wood, plastics or metal plates may be used for the hollowed-out character sign. While for the ground stake, opaque materials may also be used and in this regard no lamp or lamp string is arranged to pass through the ground stake.

A hook member or the like may be provided atop the ground supported lighting device of the invention so as to allow it to be suspended for indoor use.

The character sign may be hollowed-out into a variety of desirable characters so that the ground supported lighting device with such a hollowed-out character sign may serve for eye-catching and informative purposes when it is set up at two sides of roads. Further, the string of lamps arranged inside the lamp housing permits the characters conspicuous. According to the invention, it is easy and inexpensive to produce the character sign with more delicate characters than those produced by coiling up one or more lamp strings.

Having sufficiently described the nature of the present invention, it is stated that insofar as its basic principle is not altered, changed or modified it may be subjected to variations of detail. In this regard, we would highlight that the size and configuration of the character sign and the ground stake are independent of scope of the invention. The ground supported lighting device with a wood-based or metal-based character sign which is illuminated by a light source, for example, Christmas lamp, rope light or LED lamp should fall into the scope of this invention.

What is claimed is:

1. A ground lighting device for displaying information, comprising
a lamp housing constructed by a frame and at least one PVC-based panel secured to the frame;
at least one hollowed-out character sign attached to the PVC-based panel;
a hollow ground stake connected with the frame; and
a string of lamps which runs through the hollow ground stake to be arranged inside the lamp housing.

2. The ground supported lighting device for displaying information as claimed in claim 1, further comprising a hook member on top of the device so as to allow the device to be suspended.

3. The ground supported lighting device for displaying information as claimed in claim 1, wherein the hollow ground stake is transparent.

4. The ground supported lighting device for displaying information as claimed in claim 3, wherein the hollow ground stake is formed with decorative patterns.

5. The ground supported lighting device for displaying information as claimed in claim 1, wherein the hollowed-out character sign is made of wood materials.

6. The ground supported lighting device for displaying information as claimed in claim 1, wherein the hollowed-out character sign is made in the shape of an arrow, a polygon, or a rectangular configuration incorporating Santa Clause patterns.

7. The ground supported lighting device for displaying information as claimed in claim 2, wherein the hollow ground stake is transparent.

8. The ground supported lighting device for displaying information as claimed in claim 7, wherein the hollow ground stake is formed with decorative patterns.
